(19) United States
(12) Patent Application Publication
(10) Pub. No.: US 2009/0108028 A1
(43) Pub. Date: Apr. 30, 2009

(54) APPARATUSES TO DELIVER SMALL AMOUNTS OF FLUIDS AND METHODS OF USING THE SAME

(76) Inventors: David F. Duncan, Jacksonville, FL (US); Jeffrey G. Witzel, St. Augustine, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/250,732

(22) Filed: Oct. 14, 2008

Related U.S. Application Data
(60) Provisional application No. 60/982,864, filed on Oct. 26, 2007.

(51) Int. Cl. G01F 11/00

(52) U.S. Cl. 222/219

(57) ABSTRACT

This invention relates to devices and methods to deliver small amounts of fluid in a production environment.

### RELATED APPLICATION

This application is a non-provisional filing of a provisional application, U.S. Ser. No. 60/982,864, filed on Oct. 26, 2007.

This invention relates to devices and methods to deliver fluids are disclosed herein.

### BACKGROUND

Many medical devices are provided to consumers in a solution. In most cases due to the nature of such products, the amount of solution that is contained within packages for medical devices must be consistent. Contact lenses, particularly soft contact lenses are an example of a medical device that is typically delivered to the consumer in a solution. Typically contact lenses are packaged in single use containers, know as blister packages, and delivered to the consumer with about 1 mL of solution. This solution is delivered to the blister package in the final steps of the manufacturing process typically before sealing and sterilizing the lenses.

When contact lenses were first manufactured, the process was hands on and required the intervention of many workers. Developments in manufacturing have reduced the number of hands on processes and increased production speeds, but increases speeds often adds problems to the manufacturing process. Existing machinery can deliver the solution to the package, but frequent breakdowns of such machinery and an inconsistent delivery of a precise volume of solution occurs at high speeds. Current machinery requires the use of individual pumps for each package and those pumps, must deliver liquid in several small increments over at least 2.5 seconds to accurately dose about 1 mL of solution. In addition, the use of existing solution delivery devices at increased speeds produces foaming and bubbling of the solution. This condition affects the ability of further downstream processes to seal the packages prior to sterilization. Therefore it would be useful if a method and a device existed that improved these problems and this need is met by the following invention.

### BRIEF DESCRIPTION OF THE DRAWINGS

FIG. 1 illustrates a perspective drawing of the device.

FIG. 2 illustrates a perspective drawing of a disassembled device.

FIG. 3 illustrates a cross-sectional cutaway view of the device.

### DETAILED DESCRIPTION OF THE INVENTION

This invention includes a device for delivering a solution comprising
a fluid reservoir coupled to,
a housing comprising a bore therethrough, an entrance housing aperture and an exit housing aperture, wherein said housing apertures are aligned,
a shaft comprising a channel therethrough, wherein said shaft is sized to fit within said bore and to provide a fluid tight seal between said bore and said shaft,
a plunger, wherein said plunger is sized to fit within a portion of said channel, to slide between a first end of said channel to a second end of said channel, and to provide a fluid tight seal between said plunger and said channel
a motor operatively connected to said shaft for rotation of said shaft, wherein when said shaft rotates within the bore, said housing apertures and said channel align and misalign.

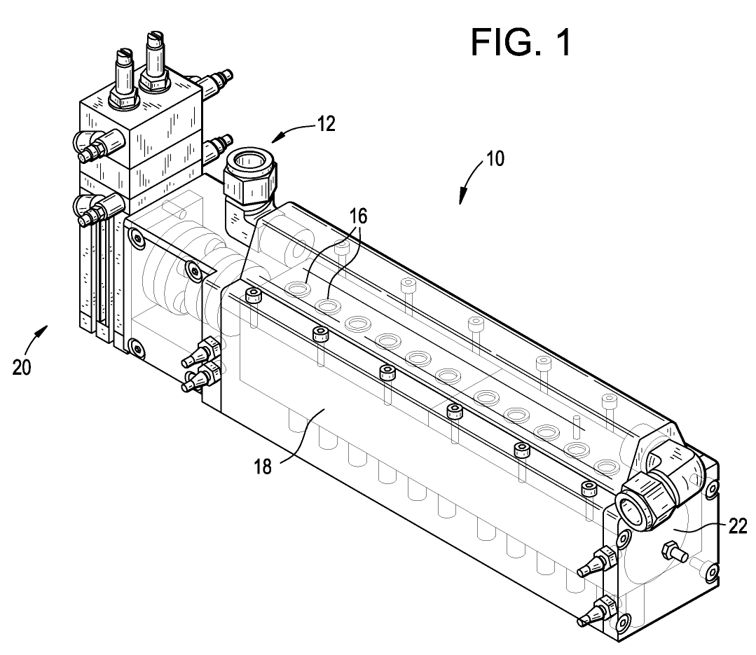

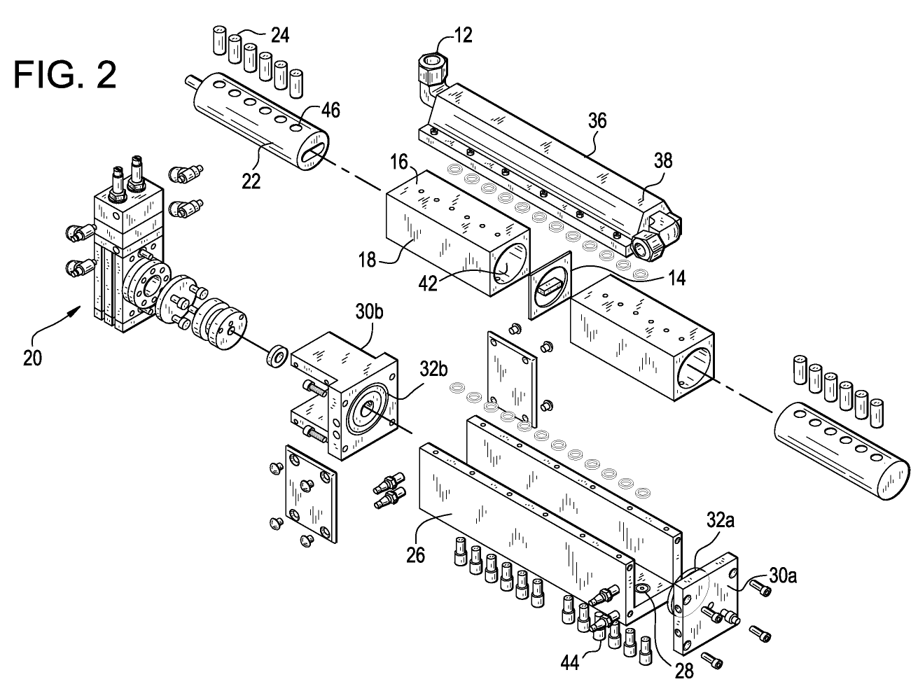

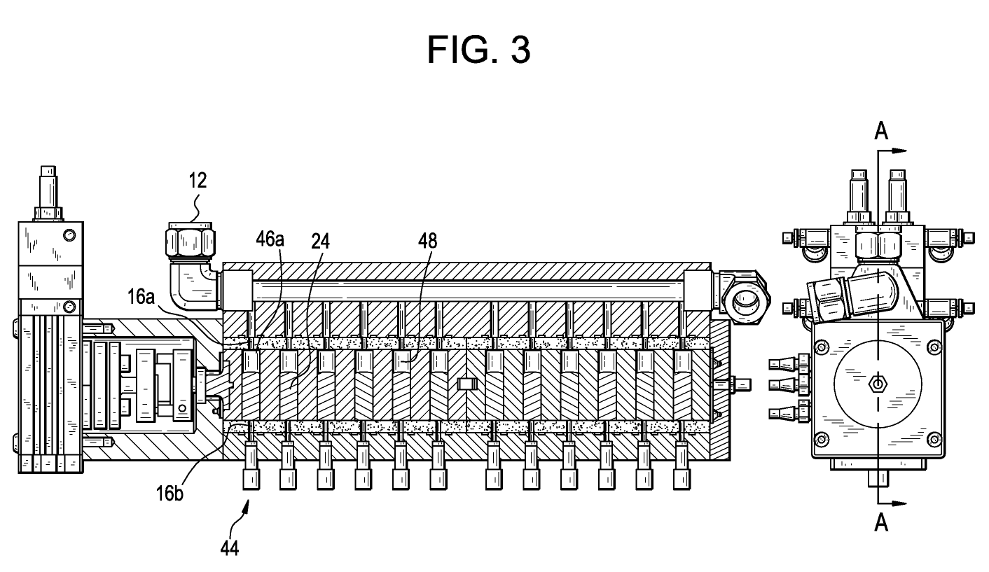

An embodiment of the invention is illustrated in FIGS. 1-3. FIG. 1 illustrates a solution deliver device 10 which is connected to a fluid reservoir (not shown) by coupling 12. Housing, 18 is a square that contains housing apertures 16 located on opposite walls of said housing (one side shown) and aligned with each other to permit objects to pass from one to the other. Motor 20 is attached to shaft 22. FIG. 2 shows a disassembled view of the device. Housing 18, bore 42, housing apertures 16 are shown, as well as shaft 22, slideable plungers 24, and channel 46. In this view housing 18 is placed into a U shaped exterior frame 26. One wall of frame 26 contains frame apertures 28 (only one shown). Frame 26 is topped with cover 36 containing channel 38 and apertures 40 (not shown). Channel 38 is coupled to coupling 12 (not shown). Frame ends 30a and 30b along with O-rings 32a, 32b, and gasket 14 are used to help provide a fluid tight seal. Fittings 44 are coupled to frame apertures 28. FIG. 3 shows a cutaway cross-sectional view of the device. Opposing walls of housing 18 are represented by a grayed section and the interior of shaft 22 is represented by diagonal lines. Plunger 24 is represented by horizontal lines within channel 46. The space above plunger 24 within channel 46 is filling volume 48.

When device 10 is used to fill packages, fluid flows or is pumped from the reservoir through coupling, 12 to channel 38 and onto housing aperture 16a, channel end 46a and filling volume 48. Then, shaft 22 turns clockwise and housing aperture 16a and channel end 46a are closed by the movement of the shaft 22, enclosing fluid within filling volume 48. As rotation continues, channel end 46a aligns with housing aperture 16b and channel end 46b aligns with housing aperture 16a. Housing aperture 16a is exposed to pressure (head pressure) from the fluid reservoir (not shown) and in response to this pressure, plunger 24 slides through channel 46. discharging the fluid contained filling volume 48 though housing aperture 16b. At the same time fluid from the reservoir flows through housing aperture 16a to fill the filling volume created by the movement of plunger 24. As rotation continues, device 10 constantly discharges a consistent volume of fluid through housing aperture 16 to fittings 44 for delivery to contact lens packages. This embodiment may be used to deliver about 100 μL to about 5 mL of solution, more preferably about 500 μL to about 2 mL, more preferably about 750 μL to about 1 mL of solution.

The housing, shaft, and plunger are made of a materials with low coefficients of expansion. The preferred materials are ceramic, such as aluminum oxide (alumina) or combinations of aluminum oxide and other components such as magnesium oxide, chromium (III) oxide, iron oxide. One commercially available material is manufactured by Resco Product Inc., and sold under the tradename, Exceline FG-95. The O-rings 32a and 32b are made of silicone, synthetic rubber or fluorelastomers. Motor 20 must be capable of rotating shaft 22. This may be accomplished by using rotary indexing motors including the following non-limiting examples: rotary air cylinder, stepper motor, sevomotor, motor/blake combination, and the like.

With respect to the fluid reservoir, fluid may be pumped through the reservoir using an external pump or fluid may flow using gravity. It is preferred that a gravity is employed to dispense fluid to the housing. When gravity is employed the dimensions of the fluid reservoir and its associated connecting pieces determines the flow rate (cm³/sec) that fluid travels to the housing. This flow rate is equivalent to the flow rate at which liquid is dispensed from the device. The relationship between the dimensions of a gravity fed fluid reservoir and its associated connecting pieces is shown by the following equations.

If one knows, the head height (“H”) namely, the height of the fluid in the fluid reservoir to the entrance point of the fluid to the housing, and the diameter (“D”) of the hose that connects the fluid to the housing, the flow rate (Q,) of that fluid may be calculated by

Flow rate=velocity of fluid (m/s)×cross sectional area of nozzle (m²)

Velocity fluid (“V”)=square root of 2×acceleration due to gravity

Q=V·Area

Q=\sqrt{2 g·H}·π(D/2)²

Q=\sqrt{2(9.8 m/s²)·H₍ₘ₎}·π(D₍ₘ₎/2)²

Similarly, the relationship between the flow rate (cm³/s) from the device to the packages, the velocity of the fluid (cm/s), the dose volume (cm³) and the time to dose (s) and the diameter (D) of the exit ports of the device is demonstrated by the following equations.

Flow rate=velocity of fluid (cm/s)×cross sectional area of nozzle (cm²).

For example is one wants to dose 950 μL (0.950 cm³) in 0.5 seconds, the flow rate is 1.9 cm³/s. If the interior diameter of the exit nozzle is 2 mm, the cross sectional area of that nozzle is 0.031415 cm². These numbers may be used to calculate the velocity of the fluid, namely 60.5 cm/s.

Further the invention includes a method of delivering small amounts of fluid in a production environment comprising
passing fluid from a fluid reservoir to an apparatus comprising
   a housing comprising a bore therethrough, an entrance housing aperture and an exit housing aperture, wherein said housing apertures are aligned,
   a shaft comprising a channel therethrough, wherein said shaft is sized to fit within said bore and to provide a fluid tight seal between said bore and said shaft,
   a plunger, wherein said plunger is sized to fit within a portion of said channel, to slide between a first end of said channel to a second end of said channel, and to provide a fluid tight seal between said plunger and said channel
   a motor operatively connected to said shaft for rotation of said shaft
rotating said shaft to slide said plunger towards the second end of said channel and to permit fluid to flow from said fluid reservoir through said entrance housing aperture to said channel,
rotating said shaft to enclose fluid contained within said channel
rotating said shaft to discharge fluid from said channel through said first end of said channel and said exit housing aperture, and to slide said plunger towards said first end of said channel and to permit fluid from said reservoir to flow through said entrance housing aperture and said second end of said channel to said channel.

The amount of bubbles and foaming that are discharged to the package is greatly reduced using this method instead of known methods of the invention. In addition, since the preferred methods of the invention use gravity to supply the fluid, both energy and equipment costs are saved using the apparatuses and methods of the invention. Although this invention may be used to accurately deliver small amounts of fluid to may different types of packages, the methods and apparatuses of this invention are particularly suited to the delivering packaging solutions to ophthalmic lens packages. In this application the number of housing apertures is increased to permit multiple packages to be dosed simultaneously. Preferably there are at least three entrance housing apertures and at least three exit housing apertures. As is demonstrated by the invention, the number of channels in such a device is at least three as well.

In addition as illustrated in the drawings more than one housing may be coupled together using gaskets, O-rings and the like to produce multiple dosing sites.

As used herein, “ophthalmic lens” refers to a device that resides in or on the eye. These devices can provide optical correction or may be cosmetic. Ophthalmic lenses include but are not limited to soft contact lenses, intraocular lenses, overlay lenses, ocular inserts, and optical inserts. The particularly preferred ophthalmic lenses of the inventions are know by the United States Approved Names of etafilcon A, genfilcon A, lenefilcon A, lotrifilcon A, lotrifilcon B, balifilcon A, polymacon, bafilcon, acofilcon A acquafilcon A, alofilcon A alphafilcon A, amifilcon A, astifilcon A, atalafilcon A, bisfilcon A bufilcon A, crofilcon A, cyclofilcon A, darfilcon A deltafilcon A, deltafilcon B, dimefilcon A, drooxifilcon A, epsifilcon A, esterifilcon A, focofilcon A, galyfilcon A, govafilcon A, hefilcon A hefilcon B, hefilcon D, hilafilcon A, hilafilcon B, hixoifilcon A, hioxifilcon B, hioxifilcon C, hydrofilcon A, lenefilcon A, licryfilcon A, licryfilcon B, lidofilcon B, lidofilcon A, mafilcon A, mesifilcon A, methafilcon B, mipafilcon A, nelfilcon A, netrafilcon A, ocufilcon A, ocufilcon B, ocufilcon C, ocufilcon D, ocufilcon E, ofilcon A, omafilcon A, oxyfilcon A, pentafilcon A, perfilcon A, pevafilcon A, phemfilcon A, senofilcon A, silafilcon A, siloxyfilcon A, tefilcon A, tetrafilcon A, trifilcon A, or xylofilcon A. More particularly preferred ophthalmic lenses of the invention are genfilcon A, lenefilcon A, lotrfilcon A, lotrifilcon B, or balifilcon A. The most preferred lenses include but are not limited to etafilcon A, nelfilcon A, hilafilcon, and polymacon.

Many ophthalmic lenses are packaged in individual blister packages, sealed and sterilized prior to dispensing the lenses to users. Examples of blister packages and sterilization techniques are disclosed in the following references which are hereby incorporated by reference in their entirety, U.S. Pat. Nos. D435,966 S; 4,691,820; 5,467,868; 5,704,468; 5,823,327; 6,050,398, 5,696,686; 6,018,931; 5,577,367; and 5,488,815.

The “packaging solutions” that are used in this method of treatment may be water-based solutions. Typical solutions include, without limitation, saline solutions, other buffered solutions, and deionized water. The preferred aqueous solution is deioinized water or saline solution containing salts including, without limitation, sodium chloride, sodium borate, sodium phosphate, sodium hydrogenphosphate, sodium dihydrogenphosphate, or the corresponding potassium salts of the same. These ingredients are generally combined to form buffered solutions that include an acid and its conjugate base, so that addition of acids and bases cause only a relatively small change in pH. The buffered solutions may additionally include 2-(N-morpholino)ethanesulfonic acid (MES), sodium hydroxide, 2,2-bis(hydroxymethyl)-2,2′,2″-nitrilotriethanol, n-tris(hydroxymethyl)methyl-2-aminoethanesulfonic acid, citric acid, sodium citrate, sodium carbonate, sodium bicarbonate, acetic acid, sodium acetate, ethylenediamine tetraacetic acid and the like and combinations thereof. Preferably, the packaging solution is a borate buffered or phosphate buffered saline solution or deionized water.

The foregoing description of the invention is not meant to limit the invention, merely to illustrate its use. Other modifications that are considered to be within the scope of the invention, and will be apparent to those of the appropriate skill level in view of the foregoing text.

What is claimed is:

1. A device for delivering a solution comprising
a fluid reservoir coupled to,
a housing comprising a bore therethrough, an entrance housing aperture and an exit housing aperture, wherein said housing apertures are aligned,
a shaft comprising a channel therethrough, wherein said shaft is sized to fit within said bore and to provide a fluid tight seal between said bore and said shaft,
a plunger, wherein said plunger is sized to fit within a portion of said channel, to slide between a first end of said channel to a second end of said channel, and to provide a fluid tight seal between said plunger and said channel
a motor operatively connected to said shaft for rotation of said shaft, wherein when said shaft rotates within the bore, said housing apertures and said channel align and misalign.

2. The device of claim 1 wherein the plunger and channel are sized to that between about 100 μL and about 5 mL of solution may be added to channel with a plunger inserted therein.

3. The device of claim 1 wherein the plunger and channel are sized to that between about 500 μL and about 2 mL of solution may be added to channel with a plunger inserted therein.

4. The device of claim 1 wherein the plunger and channel are sized to that between about 700 μL and about 1 mL of solution may be added to channel with a plunger inserted therein.

5. The device of claim 1 comprising at least three entrance housing apertures and at least three exit housing apertures

6. The device of claim 1 comprising
two housings, wherein each housing comprises a bore therethrough, at least three entrance housing apertures and three exit housing apertures, wherein said housing apertures are aligned,
two shafts, wherein each shaft comprises three channels therethrough, wherein said shaft is sized to fit within said bore and to provide a fluid tight seal between said bore and said shaft,
six plungers wherein each of said plunger is sized to fit within a portion of said channels, to slide between a first end of said channel to a second end of said channel, and to provide a fluid tight seal between said plunger and said channel

7. A method of delivering small amounts of fluid in a production environment comprising
passing fluid from a fluid reservoir to an apparatus comprising
a housing comprising a bore therethrough, an entrance housing aperture and an exit housing aperture, wherein said housing apertures are aligned,
a shaft comprising a channel therethrough, wherein said shaft is sized to fit within said bore and to provide a fluid tight seal between said bore and said shaft,
a plunger, wherein said plunger is sized to fit within a portion of said channel, to slide between a first end of said channel to a second end of said channel, and to provide a fluid tight seal between said plunger and said channel
a motor operatively connected to said shaft for rotation of said shaft
rotating said shaft to slide said plunger towards the second end of said channel and to permit fluid to flow from said fluid reservoir through said entrance housing aperture to said channel,
rotating said shaft to enclose fluid contained within said channel
rotating said shaft to discharge fluid from said channel through said first end of said channel and said exit housing aperture, and to slide said plunger towards said first end of said channel and to permit fluid from said reservoir to flow through said entrance housing aperture and said second end of said channel to said channel.

8. The method of claim 7 wherein the small amount of fluid is between about 100 μL and about 5 mL.

9. The method of claim 7 wherein the small amount of fluid is between about 500 μL and about 2 mL

10. The method of claim 7 wherein the small amount of fluid is between about 700 μL and about 1 mL.
